(19) United States
(12) Patent Application Publication
(10) Pub. No.: US 2009/0050852 A1
(43) Pub. Date: Feb. 26, 2009

(54) Metal Oxide Particle-Containing Polysiloxane Composition and Method for Producing Same

(75) Inventors: Tarou Kanamori, Tokyo (JP); Tatsuya Shimizu, Tokyo (JP); Keisuke Yajima, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, Chuo-ku, Tokyo (JP)

(21) Appl. No.: 12/295,439

(22) PCT Filed: Mar. 27, 2007
(86) PCT No.: PCT/JP2007/056287

§ 371 Date: Sep. 30, 2008

(30) Foreign Application Priority Data
Mar. 31, 2006 (JP) 2006-100014

(51) Int. Cl. C09K 11/02; C08K 3/22

(52) U.S. Cl. 252/301.36; 524/430

(57) ABSTRACT

The metal oxide fine particle-containing polysiloxane composition of the present invention is obtained by mixing (A) metal oxide fine particles with (B1) polyfunctional polysiloxane obtained by allowing alkoxy-terminated polyfunctional polysiloxane (b1) represented by the following average compositional formula (1): R¹ₐSiO_{b}(OR²)_{c} (1) (wherein R¹ is a hydrogen atom or a monovalent hydrocarbon group having no oxyalkylene group, R² is an alkyl group, a is more than 0 but less than 2, b is more than 0 but less than 2, c is more than 0 but less than 4, and a+b×2+c=4) and having a weight-average molecular weight of not less than 3,000 but not more than 100,000 and hydroxy-terminated hydroxy-terminated polydimethylsiloxane (b2) having a weight-average molecular weight of not less than 2,000 but not more than 100,000 to undergo dealcoholization reaction in a specific ratio, in an organic solvent in the presence of a basic compound, an acidic compound or a metal chelate compound and thereby dispersing the metal oxide fine particles (A) in the organic solvent.

### TECHNICAL FIELD

The present invention relates to a polysiloxane composition wherein metal oxide fine particles are highly dispersed in an organic solvent containing polyfunctional polysiloxane having a dimethylsiloxane chain, and a cured product of the composition.

### BACKGROUND ART

As a means to impart various functions to siloxane materials having excellent durability, combining of a binder having a siloxane skeleton (also referred to as a “siloxane-based binder” hereinafter) with various metal oxides has been studied in the past. As one of the siloxane-based binders, polydimethylsiloxane is known. This polydimethylsiloxane is not deteriorated unless the ambient temperature is a high temperature of usually not lower than 200° C., and it is useful as a siloxane-based binder excellent in heat resistance and ultraviolet light resistance. Moreover, the polydimethylsiloxane is excellent also in flexibility, and therefore, it is used for various purposes. However, when metal oxide fine particles are added in order to impart various functions to polydimethylsiloxane, a composition containing them is inferior in dispersing properties, and a cured product of the composition is liable to be whitened. Even if a transparent coating film is obtained, there resides a problem that when the film is stored at high temperature and high humidity, it is decreased in weight with time and is whitened.

In the case where the siloxane-based binder and a metal oxide are combined, they are frequently prepared in the form of dispersions. The siloxane-based binder, however, is hardly dissolved in water, and hence, it is necessary to use an organic solvent as a dispersion medium. On the other hand, the metal oxide fine particles are liable to be aggregated in an organic solvent, and hence, they are frequently dispersed in an aqueous medium. On this account, in order to finely disperse the metal oxide fine particles in an organic solvent, it is necessary to use phosphoric acid, sulfonic acid or carboxylic acid having an organic group of 6 or more carbon atoms (see patent document 1), an organic compound having an oxyalkylene group or an ester of phosphoric acid or the like having an oxyalkylene group (see patent document 2), or a silane compound having an oxyalkylene group (see patent document 3).

In the case where the metal oxide fine particles and the siloxane-based binder are combined by the method of finely dispersing the metal oxide fine particles in an organic solvent using the above compounds, dispersing properties of the dispersion are excellent, but compatibility of the above compounds with the siloxane-based binder is bad, and for example, when the solvent is removed to form a coating film, the coating film is sometimes whitened. Further, even if a transparent coating film is formed by controlling the film-forming conditions, etc., phosphoric acid or the like having an organic group of 6 or more carbon atoms or a compound having an oxyalkylene group remains in the coating film, and consequently, disadvantages, such as coloring of the coating film and occurrence of a crack, are sometimes brought about in severe environment such as environment under irradiation with ultraviolet light or at high temperatures of not lower than 150° C.

In the case where a transparent coating film is formed by the use of a conventional polysiloxane composition containing metal oxide fine particles, the polysiloxane composition contains a dispersion solvent of usually 30 to 90% by weight, and in order to secure dispersion stability of the metal oxide fine particles, the viscosity of the composition, as measured by an E type viscometer under the conditions of 25° C. and a rotor rotational speed of 5 rpm, is adjusted to a low viscosity of usually not more than 15 mPa·s. If a filler having a high specific gravity is added to the metal oxide fine particle-containing polysiloxane composition of such a low viscosity, the filler sometimes suffers sedimentation separation. On this account, an organic thickening agent such as polyethylene glycol has been added to increase viscosity in the past. However, because of heat or ultraviolet light, coloring or cracking occurs, and resistances, such as heat resistance and ultraviolet light resistance, are deteriorated. Although the viscosity can be increased by, for example, increasing a solids concentration without adding the organic thickening agent such as polyethylene glycol, the siloxane-based binder sometimes gels, or the metal oxide fine particles are sometimes sedimented.

Patent document 1: Japanese Patent Laid-Open Publication No. 283822/2004

Patent document 2: Japanese Patent Laid-Open Publication No. 185924/2005

Patent document 3: Japanese Patent Laid-Open Publication No. 99879/2004

### DISCLOSURE OF THE INVENTION

### Problem to be Solved by the Invention

The present invention is intended to solve such problems associated with the prior art as mentioned above, and it is an object of the invention to provide a polysiloxane-based cured product which has excellent transparency, hardly suffers yellowing or decomposition deterioration even at high temperatures and is excellent in heat resistance, ultraviolet light resistance and wet heat resistance, a polysiloxane composition in which metal oxide fine particles are highly dispersed and from which such a cured product as above is obtained, and a process for preparing the composition.

### Means to Solve the Problem

The present inventors have earnestly studied in order to solve the above problems, and as a result, they have found that if a cured product containing polydimethylsiloxane and metal oxide fine particles is held at high humidity, polydimethylsiloxane is decomposed to cause deterioration of the cured product. Although details of this decomposition mechanism have not been made clear, this deterioration is presumed to be hydrolysis deterioration of polydimethylsiloxane. The present inventors have further found that the hydrolysis deterioration of polydimethylsiloxane tends to occur as the primary particle diameters of the metal oxide fine particles become smaller. Then, the metal oxide fine particles were subjected to surface treatment with a silane coupling agent such as a silane monomer, but the hydrolysis deterioration of polydimethylsiloxane could not be sufficiently inhibited. On the other hand, the present inventors have also found that even if polyfunctional polysiloxane is held at high humidity in the presence of metal oxide fine particles, it does not suffer hydrolysis decomposition. Although the main cause for that polyfunctional siloxane does not suffer decomposition deterioration at high humidity has not been made clear, it is presumed that because polyfunctional polysiloxane has a three-dimensional structure or a ladder structure, the main chain (Si—O bond) is protected by its steric hindrance effect, and the polyfunctional polysiloxane is hardly subject to hydrolysis action caused by metal oxide fine particles and water.

The present inventors have found that a polysiloxane composition wherein oxide fine particles are highly dispersed in an organic solvent containing polysiloxane is obtained by beforehand allowing hydroxy-terminated polydimethylsiloxane and alkoxy-terminated polyfunctional polysiloxane of a high molecular weight, or alkoxy group-containing polydimethylsiloxane and silanol-terminated polyfunctional polysiloxane of a high molecular weight to undergo dealcoholization reaction to form polyfunctional polysiloxane having a dimethylsiloxane chain and treating metal oxide fine particles in an organic solvent containing this polyfunctional polysiloxane in the presence of a basic compound, an acidic compound or a metal chelate compound. The present inventors have further found that a cured product obtained from this composition has excellent transparency, hardly suffers yellowing or decomposition deterioration even at high temperatures and is excellent in heat resistance, ultraviolet light resistance and wet heat resistance, and they have achieved the present invention.

That is to say, the metal oxide fine particle-containing polysiloxane composition according to the present invention is obtained by mixing:

(A) metal oxide fine particles with

(B1) polyfunctional polysiloxane which is obtained by allowing alkoxy-terminated polyfunctional polysiloxane (b1) represented by the following average compositional formula (1):

R¹ₐSiO_{b}(OR²) (1)

wherein R¹ is a hydrogen atom or a monovalent hydrocarbon group having no oxyalkylene group, when plural R¹ are present, they may be the same as or different from one another, R² is an alkyl group, when plural R² are present, they may be the same as or different from one another, a is more than 0 but less than 2, b is more than 0 but less than 2, c is more than 0 but less than 4, and a+b×2+c=4, and

having a weight-average molecular weight, as measured by gel permeation chromatography, of not less than 3,000 but not more than 100,000 in terms of polystyrene, and hydroxy-terminated polydimethylsiloxane (b2) having a weight-average molecular weight, as measured by gel permeation chromatography, of not less than 2,000 but not more than 100,000 in terms of polystyrene to undergo dealcoholization reaction in a weight ratio (b1/b2) of 30/70 to 95/5 based on 100 parts by weight of the total thereof, or

(B2) polyfunctional polysiloxane which is obtained by allowing hydroxy-terminated polyfunctional polysiloxane (b3) represented by the following average compositional formula (1′):

R¹ₐSiO_{b}(OH)_{c} (1′)

wherein R¹ is a hydrogen atom or a monovalent hydrocarbon group having no oxyalkylene group, when plural R¹ are present, they may be the same as or different from one another, a is more than 0 but less than 2, b is more than 0 but less than 2, c is more than 0 but less than 4, and a+b×2+c=4, and

having a weight-average molecular weight, as measured by gel permeation chromatography, of not less than 3,000 but not more than 100,000 in terms of polystyrene, and alkoxy-terminated polydimethylsiloxane (b4) having a weight-average molecular weight, as measured by gel permeation chromatography, of not less than 2,000 but not more than 100,000 in terms of polystyrene to undergo dealcoholization reaction in a weight ratio (b3/b4) of 30/70 to 95/5 based on 100 parts by weight of the total thereof,

in an organic solvent in the presence of a basic compound, an acidic compound or a metal chelate compound and thereby dispersing the metal oxide fine particles (A) in the organic solvent.

It is preferable that the polyfunctional polysiloxane (B1) or (B2) is further subjected to hydrolysis/condensation and then mixed with the metal oxide fine particles (A).

It is preferable that a catalyst in the hydrolysis/condensation is a basic catalyst.

It is preferable that a catalyst in the dealcoholization reaction is a metal chelate compound.

It is preferable that the metal oxide fine particles (A) and the polyfunctional polysiloxane (B1) or (B2) are mixed in the presence of the basic compound.

It is preferable that the metal oxide fine particles (A) and the polyfunctional polysiloxane (B1) or (B2) are mixed by a bead mill.

It is preferable that the polyfunctional polysiloxane (B1) or (B2) is mixed in an amount of 1 to 1000 parts by weight in terms of a perfect hydrolysis condensate, based on 100 parts by weight of the metal oxide fine particles (A).

The cured product according to the present invention is obtained from the above-mentioned metal oxide fine particle-containing polysiloxane composition.

The LED sealing material according to the present invention is obtained by further mixing the above-mentioned metal oxide fine particle-containing polysiloxane composition with a fluorescent substance.

The process for preparing a metal oxide fine particle-containing polysiloxane composition according to the present invention comprises preparing:

(B1) polyfunctional polysiloxane which is obtained by allowing alkoxy-terminated polyfunctional polysiloxane (b1) represented by the following average compositional formula (1):

R¹ₐSiO_{b}(OR²)_{c} (1)

wherein R¹ is a hydrogen atom or a monovalent hydrocarbon group having no oxyalkylene group, when plural R¹ are present, they may be the same as or different from one another, R² is an alkyl group, when plural R² are present, they may be the same as or different from one another, a is more than 0 but less than 2, b is more than 0 but less than 2, c is more than 0 but less than 4, and a+b×2+c=4, and

having a weight-average molecular weight, as measured by gel permeation chromatography, of not less than 3,000 but not more than 100,000 in terms of polystyrene, and hydroxy-terminated polydimethylsiloxane (b2) having a weight-average molecular weight, as measured by gel permeation chromatography, of not less than 2,000 but not more than 100,000 in terms of polystyrene to undergo dealcoholization reaction in a weight ratio (b1/b2) of 30/70 to 95/5 based on 100 parts by weight of the total thereof, or

(B2) polyfunctional polysiloxane which is obtained by allowing hydroxy-terminated polyfunctional polysiloxane (b3) represented by the following average compositional formula (1′):

R¹ₐSiO_{b}(OH)_{c} (1)

wherein R¹ is a hydrogen atom or a monovalent hydrocarbon group having no oxyalkylene group, when plural R¹ are present, they may be the same as or different from one another, a is more than 0 but less than 2, b is more than 0 but less than 2, c is more than 0 but less than 4, and a+b×2+c=4, and

having a weight-average molecular weight, as measured by gel permeation chromatography, of not less than 3,000 but not more than 100,000 in terms of polystyrene, and alkoxy-terminated polydimethylsiloxane (b4) having a weight-average molecular weight, as measured by gel permeation chromatography, of not less than 2,000 but not more than 100,000 in terms of polystyrene to undergo dealcoholization reaction in a weight ratio (b3/b4) of 30/70 to 95/5 based on 100 parts by weight of the total thereof,

and then mixing the polyfunctional polysiloxane (B1) or (B2) with metal oxide fine particles (A) in an organic solvent in the presence of a basic compound, an acidic compound or a metal chelate compound.

It is preferable that the polyfunctional polysiloxane (B1) or (B2) is further subjected to hydrolysis/condensation and then mixed with the metal oxide fine particles (A).

It is preferable that a catalyst in the hydrolysis/condensation is a basic catalyst.

It is preferable that a catalyst in the dealcoholization reaction is a metal chelate compound.

It is preferable that the metal oxide fine particles (A) and the polyfunctional polysiloxane (B1) or (B2) are mixed in the presence of the basic compound.

It is preferable that the metal oxide fine particles (A) and the polyfunctional polysiloxane (B1) or (B2) are mixed by a bead mill.

### EFFECT OF THE INVENTION

According to the present invention, a composition wherein metal oxide fine particles are highly dispersed in an organic solvent containing polysiloxane having a dimethylsiloxane chain is obtained without using phosphoric acid or the like having an organic group of 6 or more carbon atoms or a compound having an oxyalkylene group. This composition not only has excellent dispersion stability but also can form a transparent cured product containing metal oxide fine particles and the above polysiloxane. Moreover, because the polysiloxane contains polyfunctional polysiloxane having a dimethylsiloxane chain of an appropriate length and a three-dimensional structure or a ladder structure, a cured product having excellent flexibility and a large film thickness can be formed, and besides, a cured product which hardly suffers yellowing or decomposition deterioration even at high temperatures and is excellent in heat resistance, ultraviolet light resistance and wet heat resistance is obtained. In particular, a cured product using metal oxide fine particles of high refraction properties as the metal oxide fine particles can be used as a sealing material of an LED element using a blue LED element or an ultraviolet LED element as a light emission element, and is particularly useful as a sealing material of an LED element of high luminance.

### BEST MODE FOR CARRYING OUT THE INVENTION

The metal oxide fine particle-containing polysiloxane composition of the invention can be obtained by mixing metal oxide fine particles (A) with polyfunctional polysiloxane (B) having a dimethylsiloxnae chain in an organic solvent in the presence of a basic compound, an acidic compound or a metal chelate compound and thereby performing dispersing treatment, without using phosphoric acid or the like having an organic group of 6 or more carbon atoms or a compound having an oxyalkylene group.

Metal Oxide Fine Particles (A)

The metal oxide fine particles (A) for use in the invention are not specifically restricted in their types provided that they are fine particles of an oxide of a metal element, and examples thereof include fine particles of metal oxides, such as antimony oxide, zirconium oxide, anatase titanium oxide, rutile titanium oxide, brookite titanium oxide, zinc oxide, tantalum oxide, indium oxide, hafnium oxide, tin oxide, niobium oxide, aluminum oxide, cerium oxide, scandium oxide, yttrium oxide, lanthanum oxide, praseodymium oxide, neodymium oxide, samarium oxide, europium oxide, gadolinium oxide, terbium oxide, dysprosium oxide, holmium oxide, erbium oxide, thulium oxide, ytterbium oxide, lutetium oxide, calcium oxide, gallium oxide, lithium oxide, strontium oxide, tungsten oxide, barium oxide and magnesium oxide, composites of these oxides, and oxides of composites of two or more kinds of the above metals, such as indium-tin composite oxide.

In the present invention, the metal oxide fine particles may be used singly or as a mixture of two or more kinds. The metal oxide fine particles (A) can be properly selected according to the function to be imparted, and for example, in order to impart high refraction properties, TiO₂ fine particles are preferable, in order to make transparency in the ultraviolet region and high refraction properties be compatible with each other, ZrO₂ fine particles are preferable, and in order to impart UV cut-off function, cerium oxide fine particles or zinc oxide fine particles are preferable.

The average primary particle diameter of the metal oxide fine particles (A) is in the range of preferably 0.1 to 100 nm, more preferably 0.1 to 70 nm, particularly preferably 0.1 to 50 nm. When the average primary particle diameter of the metal oxide fine particles (A) is in the above range, a cured product having excellent light transmittance can be obtained.

Such metal oxide fine particles (A) may be added in the form of a powder that is not dissolved in a solvent, or may be added in the form of a dispersion wherein the particles are dispersed in a polar solvent such as isopropyl alcohol or a non-polar solvent such as toluene. The metal oxide fine particles (A) before adding may be agglomerated to form secondary particles. In the present invention, it is preferable to use a powder from the viewpoint that an appropriate organic solvent can be properly selected taking solubility of the polyfunctional polysiloxane (B) into account. The preparation process of the invention is particularly effective for the case of adding the metal oxide fine particles in the form of a powder.

Polyfunctional Polysiloxane (B)

The polyfunctional polysiloxane (B) for use in the invention is polyfunctional polysiloxane having a dimethylsiloxane chain, and there can be mentioned polysiloxane (B1) which is obtained by allowing alkoxy-terminated polyfunctional polysiloxane (b1) having a weight-average molecular weight, as measured by gel permeation chromatography, of not less than 3,000 but not more than 100,000 in terms of polystyrene and hydroxy-terminated polydimethylsiloxane (b2) having a weight-average molecular weight, as measured by gel permeation chromatography, of not less than 2,000 but not more than 100,000 in terms of polystyrene to undergo dealcoholization reaction, or polysiloxane (B2) which is obtained by allowing hydroxy-terminated polyfunctional polysiloxane (b3) having a weight-average molecular weight, as measured by gel permeation chromatography, of not less than 3,000 but not more than 100,000 in terms of polystyrene and alkoxy-terminated polydimethylsiloxane (b4) having a weight-average molecular weight, as measured by gel permeation chromatography, of not less than 2,000 but not more than 100,000 in terms of polystyrene to undergo dealcoholization reaction.

(b1) Alkoxy-Terminated Polyfunctional Polysiloxane

The alkoxy-terminated polyfunctional polysiloxane (b1) for use in the invention is polyfunctinal polysiloxane having an alkoxy group and represented by the following average compositional formula (I).

R¹ₐSiO_{b}(OR²)_{c} (1)

In the formula (1), R¹ is a hydrogen atom or a monovalent hydrocarbon group having no oxyalkylene group, when plural R¹ are present, they may be the same as or different from one another, R² is an alkyl group, when plural R² are present, they may be the same as or different from one another, a is more than 0 but less than 2, b is more than 0 but less than 2, c is more than 0 but less than 4, and a+b×2+c=4. When plural R¹ and plural R² are present, a indicates a ratio of the total of hydrogen atoms and monovalent hydrocarbon groups having no oxyalkylene group to silicon atoms, and c indicates a ratio of alkoxy groups to silicon atoms.

The weight-average molecular weight of the alkoxy-terminated polysiloxane (b1), as measured by gel permeation chromatography, is not less than 3,000 but not more than 100,000, more preferably not less than 3,000 but not more than 80,000, particularly preferably not less than 3,500 but not more than 50,000, in terms of polystyrene. When the alkoxy-terminated polysiloxane (b1) having a weight-average molecular weight of the above range is used, inhibition of occurrence of a crack in the formation of a cured product and inhibition of decomposition deterioration under heat and humidity are compatible with each other.

Although the monovalent hydrocarbon group is not specifically restricted provided that it has no oxyalkylene group, a substituted or unsubstituted monovalent hydrocarbon group can be mentioned as the monovalent hydrocarbon group. The monovalent unsubstituted hydrocarbon group is, for example, an alkyl group of 1 to 8 carbon atoms, a phenyl group, a benzyl group or a tolyl group. Examples of the alkyl groups of 1 to 8 carbon atoms include methyl, ethyl, propyl, isopropyl, butyl, pentyl, hexyl, heptyl and octyl. The monovalent substituted hydrocarbon group is, for example, a substituted alkyl group of 1 to 8 carbon atoms. Examples of substituents of the substituted alkyl groups include halogen, an amino group, a mercapto group, an isocyanate group, a glycidyl group, a glycidoxy group and a ureido group.

Examples of the alkyl groups indicated by R² include methyl, ethyl, propyl, isopropyl and butyl. Of these alkyl groups, methyl and ethyl are preferable.

The alkoxy-terminated polyfunctional polysiloxane (b1) can be prepared by, for example, properly combining polyfunctional alkoxysilanes or polyfunctional chlorosilanes so as to satisfy the aforesaid average compositional formula and subjecting them to hydrolysis/condensation. However, hydrolysis/condensation of tetraalkoxysilanes only and hydrolysis/condensation of dialkoxysilanes only are excluded. In the present invention, alkoxy-terminated polyfunctional polysiloxane obtained by using trifunctional alkoxysilane and/or trifunctional chlorosilane in an amount of not less than 50% by weight is particularly preferable from the viewpoint of excellent decomposition resistance in the presence of the metal oxide fine particles (A) and water.

Examples of the polyfunctional alkoxysilanes include:

tetraalkoxysilanes, such as tetramethoxysilane, tetraethoxysilane, tetra-n-propoxysilane, tetra-i-propoxysilane and tetra-n-butoxysilane;

trialkoxysilanes, such as methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, n-butyltrimethoxysilane, n-butyltriethoxysilane, n-pentyltrimethoxysilane, n-hexyltrimethoxysilane, n-heptyltrimethoxysilane, n-octyltrimethoxysilane, cyclohexyltrimethoxysilane, cyclohexyltriethoxysilane, phenyltrimethoxysilane, phenyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyltrimethoxysilane, 3-aminopropyltriethoxysilane, 3-mercaptopropyltrimethoxysilane, 3-mercaptopropyltriethoxysilane, 3-isocyanatopropyltrimethoxysilane, 3-isocyanatopropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-ureidopropyltrimethoxysilane and 3-ureidopropyltriethoxysilane; and

dialkoxysilanes, such as dimethyldimethoxysilane, dimethyldiethoxysilane, diethyldimethoxysilane, diethyldiethoxysilane, di-n-propyldimethoxysilane, di-n-propyldiethoxysilane, di-i-propyldimethoxysilane, di-i-propyldiethoxysilane, di-n-butyldimethoxysilane, di-n-butyldiethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane and diphenyldiethoxysilane. These alkoxysilanes can be used singly or as a mixture of two or more kinds.

In combination with the polyfunctional alkoxysilanes, monofunctional alkoxysilanes can be used. Examples of the monofunctional alkoxysilanes include trimethylmethoxysilane, trimethylethoxysilane, triethylmethoxysilane and triethylethoxysilane. These monofunctional alkoxysilanes are desirably used in amounts of not more than 10% by weight, preferably not more than 7% by weight, more preferably not more than 5% by weight, based on the total amount of the alkoxysilanes used.

As the alkoxy-terminated polyfunctional polysiloxanes (b1) satisfying the above molecular weight, commercially available siloxane polymers, such as XR31-B0270 and XR31-B2733 (trade names) available from GE Toshiba Silicone Co., Ltd., are also employable. The alkoxy-terminated polyfunctional polysiloxane (b1) may have a Si—OH bond within limits not detrimental to the effect of the present invention.

(b2) Hydroxy-Terminated Polydimethylsiloxane

The weight-average molecular weight of the hydroxy-terminated polydimethylsiloxane (b2) for use in the invention, as measured by gel permeation chromatography, is not less than 2,000 but not more than 100,000, more preferably not less than 2,000 but not more than 80,000, particularly preferably not less than 3,000 but not more than 70,000, in terms of polystyrene. When the hydroxy-terminated polydimethylsiloxane (b2) having a weight-average molecular weight of the above range is used, polyfunctional polysiloxane (B1) having excellent flexibility is obtained, and inhibition of occurrence of a crack in the formation of a cured product and curability are compatible with each other. Therefore, film thickening of the cured product can be promoted.

The hydroxy-terminated polydimethylsiloxane (b2) can be prepared by, for example, subjecting dimethyldialkoxysilane or dimethyldichlorosilane to hydrolysis/condensation.

Examples of the dimethyldialkoxysilanes include dimethyldimethoxysilane, dimethyldiethoxysilane, dimethyldi-i-propoxysilane and dimethyldi-n-butoxysilane. These dimethyldialkoxysilanes can be used singly or as a mixture of two or more kinds.

The hydroxy-terminated polydimethylsiloxane (b2) can be prepared also by ring-opening condensation of cyclic organosiloxane. Examples of the cyclic organosiloxanes include hexaphenylcyclotrisiloxane, octaphenylcyclotetrasiloxane, tetravinyltetramethylcyclotetrasiloxane, hexamethylcyclotrisiloxane, octamethylcyclotetrasiloxane, pentamethylcyclotetrasiloxane, hexamethylcyclotetrasiloxane, tetramethylcyclotetrasiloxane, decamethylcyclopentasiloxane and dodecamethylcyclohexasiloxane.

As the hydroxy-terminated polydimethylsiloxanes (b2) satisfying the above molecular weight, commercially available hydroxy-terminated polydimethylsiloxanes, such as YF-3057, YF-3800, YF-3802, YF-3807, YF-3897 and XF-3905 (trade names) available from GE Toshiba Silicone Co., Ltd., are also employable.

(b3) Hydroxy-Terminated Polyfunctional Polysiloxane

The hydroxy-terminated polyfunctional polysiloxane (b3) for use in the invention is polyfunctinal polysiloxane having a hydroxyl group and represented by the following average compositional formula (1′):

R¹ₐSiO_{b}(OH)_{c} (1′),

and it preferably has a three-dimensional crosslinked structure.

In the formula (1′), R¹ is defined similarly to R¹ in the aforesaid formula (1). a is more than 0 but less than 2, b is more than 0 but less than 2, c is more than 0 but less than 4, and a+b×2+c=4. When plural R¹ are present, a indicates a ratio of the total of hydrogen atoms and monovalent hydrocarbon groups having no oxyalkylene group to silicon atoms.

The weight-average molecular weight of the hydroxy-terminated polysiloxane (b3), as measured by gel permeation chromatography, is not less than 3,000 but not more than 100,000, more preferably not less than 3,000 but not more than 80,000, particularly preferably not less than 3,500 but not more than 50,000, in terms of polystyrene. When the hydroxy-terminated polysiloxane (b3) having a weight-average molecular weight of the above range is used, inhibition of occurrence of a crack in the formation of a cured product and inhibition of decomposition deterioration under heat and humidity are compatible with each other.

Although the monovalent hydrocarbon group is not specifically restricted provided that it has no oxyalkylene group, a substituted or unsubstituted monovalent hydrocarbon group can be mentioned as the monovalent hydrocarbon group. Examples of the substituted or unsubstituted monovalent hydrocarbon groups include the same substituted or unsubstituted monovalent hydrocarbon groups as previously described for the alkoxy-terminated polyfunctional polysiloxane (b1).

The hydroxy-terminated polyfunctional polysiloxane (b3) can be prepared by, for example, properly combining polyfunctional alkoxysilanes or polyfunctional chlorosilanes so as to satisfy the aforesaid average compositional formula and subjecting them to hydrolysis/condensation. However, hydrolysis/condensation of tetraalkoxysilanes only and hydrolysis/condensation of dialkoxysilanes only are excluded. In the present invention, hydroxy-terminated polyfunctional polysiloxane obtained by using trifunctional alkoxysilane and/or trifunctional chlorosilane in an amount of not less than 50% by weight is particularly preferable from the viewpoint of excellent decomposition resistance in the presence of the metal oxide fine particles (A) and water.

Examples of the polyfunctional alkoxysilanes include the same polyfunctional alkoxysilanes as previously described for the alkoxy-terminated polyfunctional polysiloxane (b1), and they can be used singly or as a mixture of two or more kinds.

Also for the hydroxy-terminated polyfunctional polysiloxane (b3), the same monofunctional alkoxysilanes as previously described for the alkoxy-terminated polyfunctional polysiloxane (b1) can be used in combination with the polyfunctional alkoxysilanes. In this case, the monofunctional alkoxysilanes are desirably used in amounts of not more than 10% by weight, preferably not more than 7% by weight, more preferably not more than 5% by weight, based on the total amount of the alkoxysilanes used.

The alkoxy-terminated polyfunctional polysiloxane (b3) may have a Si—OR bond within limits not detrimental to the effect of the present invention.

(b4) Alkoxy-Terminated Polydimethylsiloxane

The weight-average molecular weight of the alkoxy-terminated polydimethylsiloxane (b4) for use in the invention, as measured by gel permeation chromatography, is not less than 2,000 but not more than 100,000, more preferably not less than 2,000 but not more than 80,000, particularly preferably not less than 3,000 but not more than 70,000, in terms of polystyrene. When the alkoxy-terminated polydimethylsiloxane (b4) having a weight-average molecular weight of the above range is used, polyfunctional polysiloxane (B2) having excellent flexibility is obtained, and inhibition of occurrence of a crack in the formation of a cured product and curability are compatible with each other. Therefore, film thickening of the cured product can be promoted.

The alkoxy-terminated polydimethylsiloxane (b4) can be prepared by, for example, subjecting dimethyldialkoxysilane or dimethyldichlorosilane to hydrolysis/condensation.

Examples of the dialkoxysilanes include the same dialkoxysilanes as previously described for the hydroxy-terminated polydimethylsiloxane (b2), and they can be used singly or as a mixture of two or more kinds.

Process for Preparing Polyfunctional Polysiloxane (B)

The polyfunctional polysiloxane (B1) can be prepared by allowing the alkoxy-terminated polyfunctional polysiloxane (b1) and the hydroxy-terminated polydimethylsiloxane (b2) to undergo dealcoholization reaction. The polyfunctional polysiloxane (B2) can be prepared by allowing the hydroxy-terminated polyfunctional polysiloxane (b3) and the alkoxy-terminated polydimethylsiloxane (b4) to undergo dealcoholization reaction. These polyfunctional polysiloxanes (B1) and (B2) are preferably further subjected to hydrolysis/condensation after water is usually added to them. By virtue of this, the molecular weight of the polyfunctional polysiloxanes (B1) and (B2) is increased, and transparency of the resulting cured product is enhanced. Each of the above reactions is usually carried out in an organic solvent using a catalyst.

The mixing ratio by weight (b1/b2) of the alkoxy-terminated polyfunctional polysiloxane (b1) to the hydroxy-terminated polydimethylsiloxane (b2) is in the range of 30/70 to 95/5, preferably 50/50 to 95/5, more preferably 50/50 to 90/10, based on 100 parts by weight of the total thereof. The mixing ratio by weight (b3/b4) of the hydroxy-terminated polyfunctional polysiloxane (b3) to the alkoxy-terminated polydimethylsiloxane (b4) is in the range of 30/70 to 95/5, preferably 50/50 to 95/5, more preferably 50/50 to 90/10, based on 100 parts by weight of the total thereof. When the mixing ratio of the polysiloxane (b1) to the polysiloxane (b2) and the mixing ratio of the polysiloxane (b3) to the polysiloxane (b4) are in the above ranges, deterioration of the polydimethylsiloxane can be inhibited, and a cured product excellent in heat resistance, ultraviolet light resistance and wet heat resistance can be obtained. If the proportion of the alkoxy-terminated polyfunctional polysiloxane (b1) or the hydroxy-terminated polyfunctional polysiloxane (b3) is low, heat resistance, ultraviolet light resistance and wet heat resistance are lowered.

Dealcoholization Reaction

The temperature of the dealcoholization reaction is in the range of preferably 30 to 150° C., more preferably 40 to 120° C., particularly preferably 50 to 100° C. The reaction time is in the range of preferably 0.1 to 24 hours, more preferably 0.5 to 12 hours, particularly preferably 1 to 8 hours. The dealcoholization reaction may be carried out by introducing the components together into a reaction container, or may be carried out by adding one component to the other component intermittently or continuously.

Through the above dealcoholization reaction, polyfunctional polysiloxane (B1) having a structure wherein the alkoxy-terminated polysiloxane (b1) is bonded to each end of the hydroxy-terminated polydimethylsiloxane (b2) is formed, or polyfunctional polysiloxane (B2) having a structure wherein the hydroxy-terminated polysiloxane (b3) is bonded to each end of the alkoxy-terminated polydimethylsiloxane (b4) is formed.

Hydrolysis/Condensation Reaction

The amount of water added in the hydrolysis/condensation reaction is in the range of usually 1 to 500 parts by weight, preferably 10 to 300 parts by weight, more preferably 2 to 200 parts by weight, based on 100 parts by weight of the polyfunctional polysiloxane (B1) or (B2). When the amount of water added is in the above range, the hydrolysis/condensation reaction proceeds sufficiently, and the amount of water removed after the reaction is small, so that such an amount is preferable.

The temperature of the hydrolysis/condensation reaction is in the range of preferably 20 to 150° C., more preferably 30 to 100° C., particularly preferably 40 to 80° C. The reaction time is in the range of preferably 0.1 to 24 hours, more preferably 0.5 to 12 hours, particularly preferably 1 to 8 hours.

Organic Solvent

Examples of the organic solvents employable in the dealcoholization reaction and the hydrolysis/condensation reaction include alcohols, aromatic hydrocarbons, ethers, ketones and esters. Examples of the alcohols include methanol, ethanol, n-propyl alcohol, i-propyl alcohol, i-butyl alcohol, n-butyl alcohol, sec-butyl alcohol, t-butyl alcohol, n-hexyl alcohol, n-octyl alcohol, ethylene glycol, diethylene glycol, triethylene glycol, ethylene glycol monobutyl ether, ethylene glycol monoethyl ether acetate, diethylene glycol monoethyl ether, propylene glycol monomethyl ether, propylene monomethyl ether acetate and diacetone alcohol. Examples of the aromatic hydrocarbons include benzene, toluene and xylene. Examples of the ethers include tetrahydrofuran and dioxane. Examples of the ketones include acetone, methyl ethyl ketone, methyl isobutyl ketone and diisobutyl ketone. Examples of the esters include ethyl acetate, propyl acetate, butyl acetate, propylene carbonate, methyl lactate, ethyl lactate, normal propyl lactate, isopropyl lactate, methyl 3-ethoxypropionate and ethyl 3-ethoxypropionate. These organic solvents may be used singly or may be used as a mixture of two or more kinds. Of these organic solvents, organic solvents other than alcohols, such as methyl ethyl ketone, methyl isobutyl ketone, toluene and xylene, are preferably used in the dealcoholization reaction from the viewpoint of acceleration of reaction. These organic solvents are preferably subjected to dehydration treatment to remove water content prior to use.

The organic solvent can be properly used for the purpose of controlling dealcoholization reaction and hydrolysis/condensation reaction, adjusting concentration or viscosity of a solution containing the resulting polyfunctinal polysiloxane (B1) or (B2), adjusting thickness of a cured product in the production of the cured product, or the like. When the organic solvent is used, the amount of the organic solvent can be properly determined according to the desired conditions, and for example, the organic solvent is used in such an amount that the concentration of the resulting polyfunctional polysiloxane (B1) or (B2) becomes preferably 5 to 99% by weight, more preferably 7 to 95% by weight, particularly preferably 10 to 90% by weight, in terms of a perfect hydrolysis condensate.

Catalyst

The catalyst employable for the dealcoholization reaction or the hydrolysis/condensation reaction is, for example, a basic compound, an acidic compound or a metal chelate compound

Basic Compound

Examples of the basic compounds include ammonia (including ammonia aqueous solution), organic amine compounds, hydroxides of alkali metals or alkaline earth metals, such as sodium hydroxide and potassium hydroxide, and alkoxides of alkali metals, such as sodium methoxide and sodium ethoxide. Of these, ammonia and the organic amine compounds are preferable.

Examples of the organic amines include alkylamine, alkoxyamine, alkanolamine and arylamine.

Examples of the alkylamines include alkylamines having an alkyl group of 1 to 4 carbon atoms, such as methylamine, ethylamine, propylamine, butylamine, hexylamine, octylamine, N,N-dimethylamine, N,N-diethylamine, N,N-dipropylamine, N,N-dibutylamine, trimethylamine, triethylamine, tripropylamine and tributylamine.

Examples of the alkoxyamines include alkoxyamines having an alkoxy group of 1 to 4 carbon atoms, such as methoxymethylamine, methoxyethylamine, methoxypropylamine, methoxybutylamine, ethoxymethylamine, ethoxyethylamine, ethoxypropylamine, ethoxybutylamine, propoxymethylamine, propoxyethylamine, propoxypropylamine, propoxybutylamine, butoxymethylamine, butoxyethylamine, butoxypropylamine and butoxybutylamine.

Examples of the alkanolamines include alkanolamines having an alkyl group of 1 to 4 carbon atoms, such as methanolamine, ethanolamine, propanolamine, butanolamine, N-methylmethanolamine, N-ethylmethanolamine, N-propylmethanolamine, N-butylmethanolamine, N-methylethanolamine, N-ethylethanolamine, N-propylethanolamine, N-butylethanolamine, N-methylpropanolamine, N-ethylpropanolamine, N-propylpropanolamine, N-butylpropanolamine, N-methylbutanolamine, N-ethylbutanolamine, N-propylbutanolamine, N-butylbutanolamine, N,N-dimethylmethanolamine, N,N-diethylmethanolamine, N,N-dipropylmethanolamine, N,N-dibutylmethanolamine, N,N-dimethylethanolamine, N,N-diethylethanolamine, N,N-dipropylethanolamine, N,N-dibutylethanolamine, N,N-dimethylpropanolamine, N,N-diethylpropanolamine, N,N-dipropylpropanolamine, N,N-dibutylpropanolamine, N,N-dimethylbutanolamine, N,N-diethylbutanolamine, N,N-dipropylbutanolamine, N,N-dibutylbutanolamine, N-methyldimethanolamine, N-ethyldimethanolamine, N-propyldimethanolamine, N-butyldimethanolamine, N-methyldiethanolamine, N-ethyldiethanolamine, N-propyldiethanolamine, N-butyldiethanolamine, N-methyldipropanolamine, N-ethyldipropanolamine, n-propyldipropanolamine, N-butyldipropanolamine, N-methyldibutanolamine, N-ethyldibutanolamine, N-propyldibutanolamine, N-butyldibutanolamine, N-(aminomethyl)methanolamine, N-(aminomethyl)ethanolamine, N-(aminomethyl)propanolamine, N-(aminomethyl)butanolamine, N-(aminoethyl)methanolamine, N-(aminoethyl)ethanolamine, N-(aminoethyl)propanolamine, N-(aminoethyl)butanolamine, N-(aminopropyl)methanolamine, N-(aminopropyl)ethanolamine, N-(aminopropyl)propanolamine, N-(aminopropyl)butanolamine, N-(aminobutyl)methanolamine, N-(aminobutyl)ethanolamine, N-(aminobutyl)propanolamine and N-(aminobutyl)butanolamine.

Examples of the arylamines include aniline and N-methylaniline.

Examples of the organic amines other than the above amines include tetraalkylammonium hydroxides, such as tetramethylammonium hydroxide, tetraethylammonium hydroxide, tetrapropylammonium hydroxide and tetrabutylammonium hydroxide; tetraalkylethylenediamines, such as tetramethylethylenediamine, tetraethylethylenediamine, tetrapropylethylenediamine and tetrabutylethylenediamine; alkylaminoalkylamines, such as methylaminomethylamine, methylaminoethylamine, methylaminopropylamine, methylaminobutylamine, ethylaminomethylamine, ethylaminoethylamine, ethylaminopropylamine, ethylaminobutylamine, propylaminomethylamine, propylaminoethylamine, propylaminopropylamine, propylaminobutylamine, butylaminomethylamine, butylaminoethylamine, butylaminopropylamine and butylaminobutylamine; pyridine, pyrrole, piperazine, pyrrolidine, piperidine, picoline, morpholine, methylmorpholine, diazabicyclooctane, diazabicyclononane and diazabicycloundecene.

Such basic compounds may be used singly or may be used as a mixture of two or more kinds. Of these, triethylamine, tetramethylammonium hydroxide and pyridine are particularly preferable.

Acidic Compound

As the acidic compounds, organic acids and inorganic acids can be mentioned. Examples of the organic acids include acetic acid, propionic acid, butanoic acid, pentanoic acid, hexanoic acid, heptanoic acid, octanoic acid, nonanoic acid, decanoic acid, oxalic acid, maleic acid, maleic anhydride, methylmalonic acid, adipic acid, sebacic acid, gallic acid, butyric acid, mellitic acid, arachidonic acid, shikimic acid, 2-ethylhexanoic acid, oleic acid, stearic acid, linoleic acid, linolenic acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, methanesulfonic acid, phthalic acid, fumaric acid, citric acid and tartaric acid. Examples of the inorganic acids include hydrochloric acid, nitric acid, sulfuric acid, hydrofluoric acid and phosphoric acid.

Such acidic compounds may be used singly or may be used as a mixture of two or more kinds. Of these, maleic acid, maleic anhydride, methanesulfonic acid and acetic acid are particularly preferable.

Metal Chelate Compound

As the metal chelate compounds, organometallic compounds and/or partial hydrolyzates thereof (organometallic compounds and/or partial hydrolyzates thereof being together referred to as “organometallic compounds” hereinafter) can be mentioned.

The organometallic compounds are, for example, compounds represented by the following formula (a):

M(OR⁷)ᵣ(R⁸COCHCOR⁹)ₛ (a)

wherein M is at least one metal atom selected from the group consisting of zirconium, titanium and aluminum, R⁷ and R⁸ are each independently a monovalent hydrocarbon group of 1 to 6 carbon atoms, such as methyl, ethyl, n-propyl, i-propyl, n-butyl, sec-butyl, t-butyl, n-pentyl, n-hexyl, cyclohexyl or phenyl, R⁹ is the above-mentioned monovalent hydrocarbon group of 1 to 6 carbon atoms or an alkoxyl group of 1 to 16 carbon atoms, such as methoxy, ethoxy, n-propoxy, i-propoxy, n-butoxy, sec-butoxy, t-butoxy, lauryloxy or stearyloxy, and r and z are each independently an integer of 0 to 4 and satisfy the relation of (r+s)=(valence of M) (said compounds being referred to as “organometallic compounds (a)” hereinafter),

tetravalent organometallic compounds of tin wherein 1 to 2 alkyl groups of 1 to 10 carbon atoms are bonded to one tin atom (referred to as “organotin compounds” hereinafter), or

partial hydrolyzates of the above compounds.

Examples of the organometallic compounds (a) include organozirconium compounds, such as tetra-n-butoxyzirconium, tri-n-butoxy.ethyl acetoacetate zirconium, di-n-butoxy.bis(ethyl acetoacetate)zirconium, n-butoxy.tris(ethyl acetoacetate)zirconium, tetrakis(n-propyl acetoacetate)zirconium, tetrakis(acetyl acetoacetate)zirconium and tetrakis(ethyl acetoacetate)zirconium;

organotitanium compounds, such as tetra-i-propoxytitanium, di-i-propoxy.bis(ethyl acetoacetate)titanium, di-i-propoxy.bis(acetyl acetate)titanium and di-i-propoxy.bis(acetylacetone)titanium; and

organoaluminum compounds, such as tri-i-propoxyaluminum, di-i-propoxy.ethyl acetoacetate aluminum, di-i-propoxy.acetylacetonatoaluminum, i-propoxy.bis(ethyl actoacetate)aluminum, i-propoxy.bis(acetylacetonato)aluminum, tris(ethyl acetoacetate)aluminum, tris(acetylacetonato)aluminum and monoacetylacetonato.bis(ethyl acetoacetate)aluminum.

Examples of the organotin compounds include:

carboxylic acid type organotin compounds, such as

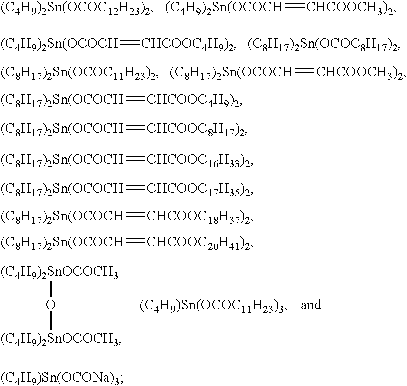

mercaptide type organotin compounds, such as

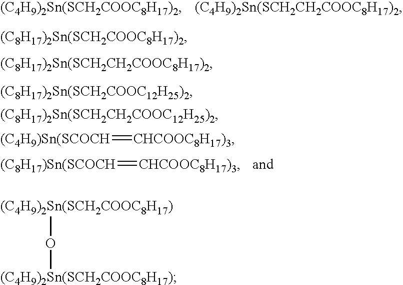

sulfide type organotin compounds, such as

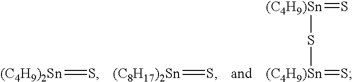

chloride type organotin compounds, such as

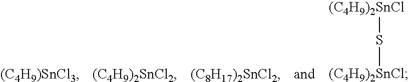

organotin oxides, such as (C₄H₉)₂SnO and (C₈H₁₇)₂SnO, and reaction products of these organotin oxides and ester compounds such as silicate, dimethyl maleate, diethyl maleatie and dioctyl phthalate.

Such metal chelate compounds may be used singly or may be used as a mixture of two or more kinds. Of these, tri-n-butoxy.ethyl acetoacetate zirconium, di-i-propoxy.bis(acetylacetonato)titanium, di-i-propoxy.ethyl acetoacetate aluminum, tris(ethyl acetoacetate)aluminum, and partial hydrolyzates of these compounds are preferable.

Of the basic compound, the acidic compound and the metal chelate compound, the metal chelate compound is preferable for the dealcoholization reaction, and the basic compound is preferable for the hydrolysis/condensation. The metal chelate compound is superior to other compounds in dealcholization reactivity. When the basic compound is used as a catalyst in the presence of water, the hydrolysis reaction rate is higher than the condensation reaction rate, and hence, the alkoxy groups remaining in the resulting polysiloxane can be decreased. As a result, volumetric shrinkage of the resulting polysiloxane can be decreased, and therefore, a cured product having excellent crack resistance can be formed.

In the dealcoholization reaction, the basic compound, the acidic compound or the metal chelate compound is added in an amount of usually 0.001 to 20 parts by weight, preferably 0.005 to 10 parts by weight, more preferably 0.01 to 5 parts by weight, based on 100 parts by weight of the total of the polyfunctional polysiloxane (b1) or (b3) and the polydimethylsiloxane (b2) or (b4).

In the hydrolysis/condensation reaction, the basic compound, the acidic compound or the metal chelate compound is added in an amount of usually 1 to 50 parts by weight, preferably 2 to 40 parts by weight, more preferably 3 to 30 parts by weight, based on 100 parts by weight of the total of the polyfunctional polysiloxane (b1) or (b3) and the polydimethylsiloxane (b2) or (b4).

From the viewpoints of storage stability of the polyfunctional polysiloxanes (B1) and (B2) obtained above and securing of dispersion stability of the metal oxide fine particles after the above step, it is preferable to carry out water washing as a catalyst removal step after the hydrolysis condensation. Especially when the basic compound is used as a hydrolysis condensation catalyst, it is more preferable to carry out water washing after performing neutralization with an acidic compound after the reaction.

As the acidic compound for use in the neutralization, the acidic compound previously described is employable. The amount of the acidic compound used is in the range of usually 0.5 to 0.2 mol, preferably 0.8 to 1.5 mol, more preferably 0.9 to 1.3 mol, based on 1 mol of the basic compound used in the hydrolysis condensation. In the case where the acidic compound is used by dissolving it in water, it is dissolved in water of usually 10 to 500 parts by weight, preferably 20 to 300 parts by weight, more preferably 30 to 200 parts by weight, based on 100 parts by weight of the total of the polyfunctional polysiloxane (b1) or (b3) and the polydimethylsiloxane (b2) or (b4). After the neutralization, the resulting solution is stirred and mixed sufficiently and then allowed to stand still to confirm phase separation between the aqueous phase and the organic solvent phase, and thereafter, water content as the lower layer is removed.

The amount of water used for water washing after neutralization is in the range of usually 10 to 500 parts by weight, preferably 20 to 300 parts by weight, more preferably 30 to 200 parts by weight, based on 100 parts by weight of the total of the polyfunctional polysiloxane (b1) or (b3) and the polydimethylsiloxane (b2) or (b4).

Water washing is carried out by adding water, sufficiently stirring the mixture, then allowing it to stand still to confirm phase separation between the aqueous phase and the organic solvent phase and removing water content as the lower layer. The number of water washing times is preferably once or more, more preferably twice or more.

The polyfunctional polysiloxanes (B1) and (B2) obtained by the above process have a weight-average molecular weight, as measured by gel permeation chromatography, of usually 3,000 to 200,000, preferably 4,000 to 150,000, more preferably 5,000 to 100,000, in terms of polystyrene.

Metal Oxide Fine Particle-Containing Polysiloxane Composition and Uses Thereof.

The metal oxide fine particle-containing polysiloxane composition of the invention can be obtained by mixing the metal oxide fine particles (A) with the polyfunctional polysiloxane (B1) or (B2) having a dimethylsiloxane chain in an organic solvent in the presence of a basic compound, an acidic compound or a metal chelate compound and thereby performing dispersing treatment, without using phosphoric acid or the like having an organic group of 6 or more carbon atoms or a compound having an oxyalkylene group.

Organic Solvent

Examples of the organic solvents include the same organic solvents as previously described for the dealcoholization reaction or the hydrolysis/condensation reaction in the preparation of the polyfunctional polysiloxane (B1) or (B2). Of these organic solvents, organic solvents other than alcohols, such as methyl ethyl ketone, methyl isobutyl ketone, diisobutyl ketone, toluene, xylene, ethyl acetate and butyl acetate, and mixtures thereof are preferable from the viewpoint that dispersion stability and high viscosity of the oxide fine particle-containing polysiloxane composition can be obtained. These organic solvents are preferably subjected to dehydration treatment to remove water content prior to use.

Although the amount of the organic solvent used is not specifically restricted provided that the metal oxide fine particles (A) can be homogeneously dispersed, the organic solvent is used in such an amount that the solids concentration of the resulting metal oxide fine particle-containing polysiloxane composition becomes preferably 5 to 80% by weight, more preferably 7 to 70% by weight, particularly preferably 10 to 60% by weight.

Basic Compound, Acidic Compound and Metal Chelate Compound

Examples of the basic compounds, the acidic compounds and the metal chelate compounds include the same compounds as previously described for the dealcoholization reaction or the hydrolysis/condensation reaction in the preparation of the polyfunctional polysiloxane (B1) or (B2). Of these basic compounds, acidic compounds and metal chelate compounds, preferable are the basic compounds and the acidic compounds, more preferable are the basic compounds, still more preferable are organic amine compounds, and particularly preferable are triethylamine, tetramethylammonium hydroxide and pyridine.

In the metal oxide fine particle-containing polysiloxane composition of the invention, the basic compound, the acidic compound or the metal chelate compound is desirably contained in an amount of usually 0.001 to 20 parts by weight, preferably 0.005 to 10 parts by weight, more preferably 0.01 to 5 parts by weight, still more preferably 0.01 to 1 part by weight, particularly preferably 0.01 to 0.5 part by weight, based on 100 parts by weight of the metal oxide fine particles (A). When the amount of the above compound is in the above range, dispersion stability of the metal oxide fine particles (A) and viscosity of the metal oxide fine particle-containing polysiloxane composition can be readily controlled.

Process for Preparing Metal Oxide Fine Particle-Containing Polysiloxane Composition

The metal oxide fine particle-containing polysiloxane composition can be prepared by adding the metal oxide fine particles (A), the polyfunctional polysiloxane (B1) or (B2) having a dimethylsiloxane chain, and the basic compound, the acidic compound or the metal chelate compound to the organic solvent, sufficiently mixing them and thereby dispersing the metal oxide fine particles (A) in the organic solvent. In this preparation, it is preferable to use a publicly known dispersing machine, such as ball mill, sand mill (bead mill, high shear bead mill), homogenizer, ultrasonic homogenizer, nanomizer, propeller mixer, high shear mixer or paint shaker. For a dispersion of particularly highly dispersed fine particles, a ball mill or a sand mill (bead mill, high shear bead mill) is preferably used. It is presumed that when the metal oxide fine particles (A) and the polyfunctional polysiloxane (B1) or (B2) are mixed in the presence of the basic compound, the acidic compound or the metal chelate compound as described above, condensation reaction of the polyfunctional polysiloxane (B1) or (B2) proceeds on the surfaces of the metal oxide fine particles (A) by virtue of the catalytic action of the basic compound, the acidic compound or the metal chelate compound, whereby the surfaces of the metal oxide fine particles (A) become hydrophobic, and the metal oxide fine particles (A) tend to be finely dispersed in the organic solvent.

In the metal oxide fine particle-containing polysiloxane composition of the invention, the polyfunctional polysiloxane (B1) or (B2) is desirably contained in an amount of preferably 1 to 1000 parts by weight, more preferably 5 to 900 parts by weight, particularly preferably 10 to 800 parts by weight, in terms of a perfect hydrolysis condensate, based on 100 parts by weight of the metal oxide fine particles (A).

The metal oxide fine particle-containing polysiloxane composition is a composition in which the metal oxide fine particles (A) having a volume-average dispersed particle diameter of not more than 300 nm, preferably not more than 200 nm, are highly dispersed.

The viscosity of the oxide fine particle-containing polysiloxane composition of the invention can be increased by extending the dispersing treatment time without using an organic thickening agent such as polyethylene glycol. Moreover, gelation and sedimentation of the oxide fine particles (A) do not occur, and even in the case where an additive of high specific gravity is mixed, sedimentation separation can be inhibited.

The oxide fine particle-containing polysiloxane composition has a viscosity, as measured by a RE80 model viscometer manufactured by Toki Sangyo Co., Ltd. under the conditions of a temperature of 25° C., a rotor rotational speed of 5 rpm and a solids concentration of 20% by weight, of preferably not less than 20 mPa·s, more preferably not less than 30 mPa·s, particularly preferably not less than 50 mPa·s. When the viscosity of the oxide fine particle-containing polysiloxane composition is in the above range, separation does not occur even if a filler of high specific gravity is added, and a cured product of a large film thickness can be readily produced.

The metal oxide fine particle-containing polysiloxane composition contains the metal oxide fine particles (A) and the polyfunctional polysiloxane (B1) or (B2) having a dimethylsiloxane chain, and it is presumed that contact of the dimethylsiloxane chain with the metal oxide fine particles can be inhibited because the polyfunctional polysiloxane (b1) or (b3) contained in the polysiloxane (B1) or (B2) is present on the surfaces of the metal oxide fine particles. Even at high temperature and high humidity, decomposition reaction of the dimethylsiloxane chain hardly occurs, and a cured product of the composition is excellent in heat resistance and wet heat resistance. Further, because the polysiloxane has excellent flexibility, a cured product having a thickness of 10 μm to 500 nm can be also formed.

Moreover, because the polyfunctional polysiloxane (B1) and (B2) have plural terminal alkoxy groups, the metal oxide fine particles (A) are highly dispersed in the composition without using phosphoric acid or the like having an organic group of 6 or more carbon atoms or a compound having an oxyalkylene group. By virtue of this, a cured product which is not deteriorated even if it is exposed to severe environment and which has excellent transparency can be formed. In this cured product, a carbon-carbon bond is not present in its crosslinked structure, and the cured product is excellent also in ultraviolet light resistance. For example, the cured product is not yellowed (does not turn yellow) even by irradiation with ultraviolet light at 5000 mW/m² for 200 hours.

The oxide fine particle-containing polysiloxane composition of the invention can further contain a fluorescent substance, and a cured product of such a composition can be used as an LED sealing material.

The oxide fine particle-containing polysiloxane composition of the invention may further contain glass fibers in order to relax shrinkage/expansion of a cured product. When a composition containing glass fibers is used, a cured product having a larger film thickness can be formed. In order to secure transparency of a cured product, a difference in refractive index between the polyfunctional polysiloxane (B1) or (B2) and the glass fibers is preferably not more than 0.01.

### EXAMPLES

The present invention is further described with reference to the following examples, but it should be construed that the invention is in no way limited to those examples. The terms “part(s)” and “%” in the examples and the comparative examples mean “part(s) by weight” and “% by weight”, respectively, unless otherwise noted. Various measurements in the examples and the comparative examples were carried out by the following methods.

GPC Measurement

Weight-average molecular weight of siloxane is indicated by a value in terms of polystyrene measured by gel permeation chromatography under the following conditions.

Apparatus: HLC-8120C (manufactured by Tosoh Corporation)

Column: TSK-gel MultiporeH_{XL}-M (manufactured by Tosoh Corporation)

Eluting solution: THF, flow rate: 0.5 mL/min, load: 5.0%, 100 μL

### Dispersibility

Appearance of the resulting composition was visually observed. Volume-average dispersed particle diameter of fine particles in a composition in which sedimentation of fine particles was not observed was measured by a microtrack ultrafine particle size distribution meter (“UPA150” manufactured by Nikkiso Co., Ltd.), and the composition was evaluated by the following criteria.

A: The composition is free from separation sedimentation. Volume-average dispersed particle diameter≦200 nm

B: The composition is free from separation sedimentation. 200 nm<Volume-average dispersed particle diameter≦300 nm

C: The composition is free from separation sedimentation. 300 nm<Volume-average dispersed particle diameter

D: The composition suffers separation sedimentation.

Thick Film-Forming Properties

The resulting composition was applied onto a quartz glass plate so that the dry film thickness would become 50 μm, thereafter dry cured at 100° C. for 1 hour and then further dry cured at 200° C. for 1 hour to prepare a cured product having a film thickness of 50 μm on the quartz glass plate. Then, appearance of the cured product was visually observed, and the cured product was evaluated by the following criteria.

A: The cured product is free from a crack.

B: The cured product suffers occurrence of a crack.

Coating Film Transparency

The resulting composition was applied onto a quartz glass plate so that the dry film thickness would become 20 μm, thereafter dry cured at 100° C. for 1 hour and then further dry cured at 200° C. for 1 hour to prepare a cured product having a film thickness of 20 μm on the quartz glass plate. Then, spectral transmittance of the cured product at a wavelength of 500 to 700 nm was measured by an ultraviolet visible spectrophotometer, and the cured product was evaluated by the following criteria.

A: Light transmittance is more than 90%.

B: Light transmittance is not less than 85% but not more than 90%.

C: Light transmittance is not less than 70& but less than 85%.

D: Light transmittance is less than 70%.

Yellowness

The resulting dispersion was applied onto a quartz glass plate so that the dry film thickness would become 20 μm, thereafter dry cured at 100° C. for 1 hour and then further dry cured at 200° C. for 1 hour to prepare a cured product having a film thickness of 20 μm on the quartz glass plate. Then, light transmittance of the cured product at a wavelength of 450 nm was measured by an ultraviolet visible spectrophotometer, and the cured product was evaluated by the following criteria.

A: Light transmittance is more than 90%.

B: Light transmittance is 70 to 90%.

C: Light transmittance is less than 70%.

Ultraviolet Light Resistance

The resulting composition was applied onto a quartz glass plate so that the dry film thickness would become 20 μm, thereafter dry cured at 100° C. for 1 hour and then further dry cured at 200° C. for 1 hour to form a cured product having a film thickness of 200 μm on the quartz glass plate. The cured product was irradiated with ultraviolet light for 200 hours by the use of a spot UV irradiation apparatus (“SP-V” manufactured by Ushio Inc.) under the conditions of an ultraviolet illuminance of 5000 mW/cm² at a wavelength of 365 nm. Thereafter, appearance of the film was visually observed, and the film was evaluated by the following criteria.

A: The film is not colored. The film is free from a crack.

B: The film is slightly colored. The film is free from a crack.

C: The film is colored. The film is free from a crack.

D: The film is colored. The film suffers occurrence of a crack.

Heat Resistance

In an aluminum tray, about 2 g (accurately weighed down to lower four places) of the resulting composition was placed, and the composition was dry cured at 100° C. for 1 hour and then at 200° C. for 1 hour to form a cured product. This cured product was stored at 150° C. for 70 hours, and the weight of the cured product was measured before and after the storage. From the following formula, retention of weight (%) was calculated, and the cured product was evaluated by the following criteria.

Retention of weight (%)=Weight of cured product after storage/Weight of cured product before storage×100

A: Retention of weight is more than 95%.

B: Retention of weight is not less than 90% but less than 95%.

C: Retention of weight is not less than 70% but less than 90%.

D: Retention of weight is less than 70%.

Wet Heat Resistance

In an aluminum tray, about 2 g (accurately weighed down to lower four places) of the resulting composition was placed, and the composition was dry cured at 100° C. for 1 hour and then at 200° C. for 1 hour to form a cured product. This cured product was stored at a temperature of 85° C. and humidity of 85% RH for 70 hours, and the weight of the cured product was measured before and after the storage. From the following formula, retention of weight (%) was calculated, and the cured product was evaluated by the following criteria.

Retention of weight (%)=Weight of cured product after storage/Weight of cured product before storage×100

A: Retention of weight is more than 95%.

B: Retention of weight is not less than 90% but less than 95%.

C: Retention of weight is not less than 70% but less than 90%.

D: Retention of weight is less than 70%.

### Preparation Example 1

In a reactor equipped with a stirrer and a reflux condenser, 60 parts by weight of alkoxy-terminated polysiloxane having Mw of 20,000 (available from GE Toshiba Silicone Co., Ltd., trade name: XR31-B2733), 40 parts by weight of hydroxy-terminated polydimethylsiloxane having Mw of 4,000 (available from GE Toshiba Silicone Co., Ltd., trade name: YF-3800), 42 parts by weight of toluene and 0.2 part by weight of an isopropyl alcohol 75% dilute solution of di-i-propoxy.ethyl acetoacetate aluminum were placed and mixed, and dealcoholization reaction was carried out at 80° C. for 3 hours with stirring. Subsequently, 288 parts by weight of methyl isobutyl ketone, 70 parts by weight of methanol, 80 parts by weight of water and 12 parts by weight of triethylamine were added, and hydrolysis/condensation reaction was carried out at 60° C. for 3 hours. Thereafter, the resulting reaction solution was neutralized with oxalic acid, and the aqueous phase (lower layer) was removed. Thereafter, water washing and removal of aqueous phase were carried out three times, and then the solvent was distilled off to obtain polyfunctional polysiloxane having Mw of 30,000. To this polyfunctional polysiloxane were added 100 parts by weight of methyl isobutyl ketone to obtain a polysiloxane solution (I) having a solids concentration of 50% by weight.

### Preparation Example 2

A polysiloxane solution (II) containing polyfunctional polysiloxane of Mw of 25,000 and having a solids concentration of 50% by weight was obtained in the same manner as in Preparation Example 1, except that the amount of the alkoxy-terminated polysiloxane (XR31-B2733) was changed to 80 parts by weight, and the amount of the hydroxy-terminated polydimethylsiloxane (YF-3800) was changed to 20 parts by weight.

### Preparation Example 3

A polysiloxane solution (III) containing polyfunctional polysiloxane of Mw of 22,000 and having a solids concentration of 50% by weight was obtained in the same manner as in Preparation Example 1, except that the amount of the alkoxy-terminated polysiloxane (XR31-B2733) was changed to 95 parts by weight, and 5 parts by weight of hydroxy-terminated polydimethylsiloxane having Mw of 10,000 (available from GE Toshiba Silicone Co., Ltd., trade name: XF-3905) were used instead of the hydroxy-terminated polydimethylsiloxane (YF-3800).

### Preparation Example 4

A polysiloxane solution (IV) containing polyfunctional polysiloxane of Mw of 33,000 and having a solids concentration of 50% by weight was obtained in the same manner as in Preparation Example 1, except that the amount of the alkoxy-terminated polysiloxane (XR31-B2733) was changed to 40 parts by weight, and the amount of the hydroxy-terminated polydimethylsiloxane (YF-3800) was changed to 60 parts by weight.

### Preparation Example 5

In a reactor equipped with a stirrer and a reflux condenser, 60 parts by weight of alkoxy-terminated polysiloxane having Mw of 20,000 (available from GE Toshiba Silicone Co., Ltd., trade name: XR31-B2733), 40 parts by weight of hydroxy-terminated polydimethylsiloxane having Mw of 4,000 (available from GE Toshiba Silicone Co., Ltd., trade name: YF-3800), 42 parts by weight of toluene and 0.2 part by weight of an isopropyl alcohol 75% dilute solution of di-i-propoxy.ethylacetoacetate aluminum were placed and mixed, and dealcoholization reaction was carried out at 80° C. for 3 hours with stirring. To the resulting reaction solution were added 58 parts by weight of methyl isobutyl ketone to obtain a polysiloxane solution (V) containing polyfunctional polysiloxane of Mw of 25,000 and having a solids concentration of 50% by weight.

### Preparation Example 6

A polysiloxane solution (i) containing polyfunctional polysiloxane of Mw of 5,000 and having a solids concentration of 50% by weight was obtained in the same manner as in Preparation Example 1, except that 60 parts by weight of an alkoxy-terminated siloxane oligomer having Mw of 1,000 (available from Shin-Etsu Chemical Co., Ltd., trade name: X40-9220) were used instead of the alkoxy-terminated polysiloxane having Mw of 10,000 (XR31-B2733).

### Preparation Example 7

A polysiloxane solution (ii) containing polyfunctional polysiloxane of Mw of 30,000 and having a solids concentration of 50% by weight was obtained in the same manner as in Preparation Example 1, except that the amount of the alkoxy-terminated polysiloxane (XR31-B2733) was changed to 20 parts by weight, and the amount of the hydroxy-terminated polydimethylsiloxane (YF-3800) was changed to 80 parts by weight.

### Example 1

In a container, 120 parts by weight of powdery rutile titanium oxide fine particles (average primary particle diameter: 30 nm), 160 parts by weight (80 parts by weight in terms of solid matter) of the polysiloxane solution (I) as a polysiloxane component, 0.1 part by weight of triethylamine and 720 parts by weight of diisobutyl ketone were placed. To this mixture, 2000 parts by weight of zirconia beads of 0.1 mm diameter were added, and the fine particles were dispersed for 6 hours by the use of a paint shaker to obtain a metal oxide fine particle-containing polysiloxane composition (1) having a solids concentration of 20% by weight. The results of evaluation of properties of this composition are set forth in Table 1.

### Examples 2 to 5

Metal oxide fine particle-containing polysiloxane compositions (2) to (5) each having a solids concentration of 20% by weight were prepared in the same manner as in Example 1, except that 160 parts by weight (80 parts by weight in terms of solid matter) of each of the polysiloxane solutions (II) to (V) were used instead of the polysiloxane solution (I). The results of evaluation of properties of these compositions are set forth in Table 1.

### Example 6

A metal oxide fine particle-containing polysiloxane composition (6) having a solids concentration of 20% by weight was prepared in the same manner as in Example 2, except that 0.1 part by weight of methanesulfonic acid was used instead of triethylamine. The results of evaluation of properties of this composition are set forth in Table 1.

### Example 7

A metal oxide fine particle-containing polysiloxane composition (7) having a solids concentration of 20% by weight was prepared in the same manner as in Example 2, except that 120 parts by weight of powdery zinc oxide fine particles (average primary particle diameter: 20 nm) were used instead of the rutile titanium oxide fine particles. The results of evaluation of properties of this composition are set forth in Table 1.

### Example 8

A metal oxide fine particle-containing polysiloxane composition (8) having a solids concentration of 20% by weight was prepared in the same manner as in Example 1, except that 120 parts by weight of powdery zirconium oxide fine particles (average primary particle diameter: 20 nm) were used instead of the rutile titanium oxide fine particles. The results of evaluation of properties of this composition are set forth in Table 1.

### Comparative Example 1

In a container, 120 parts by weight of powdery rutile titanium oxide fine particles (average primary particle diameter: 30 nm), 80 parts by weight of hydroxy-terminated polydimethylsiloxane having Mw of 4,000 (available from GE Toshiba Silicone Co., Ltd., trade name: YF-3800), 0.1 part by weight of triethylamine and 800 parts by weight of methyl ethyl ketone were placed. To this mixture, 2000 parts by weight of zirconia beads of 0.1 mm diameter were added, and the fine particles were dispersed for 6 hours by the use of a paint shaker to obtain a metal oxide fine particle-containing polysiloxane composition (C1) having a solids concentration of 20% by weight. The results of evaluation of properties of this composition are set forth in Table 2.

### Comparative Example 2

A metal oxide fine particle-containing polysiloxane composition (C2) having a solids concentration of 20% by weight was prepared in the same manner as in Example 1, except that 160 parts by weight (80 parts by weight in terms of solid matter) of the polysiloxane solution (i) were used as a polysiloxane component instead of the polysiloxane solution (I). The results of evaluation of properties of this composition are set forth in Table 2.

### Comparative Example 3

In a container, 120 parts by weight of powdery rutile titanium oxide fine particles (average primary particle diameter: 30 nm), 160 parts by weight (80 parts by weight in terms of solid matter) of the polysiloxane solution (I) as a polysiloxane component, 9 parts by weight of a polyoxyethylene alkylphosphoric ester (available from Kusumoto Chemicals, Ltd., trade name: PLADD ED151), 5 parts by weight of acetylacetone and 720 parts by weight of methyl ethyl ketone were placed. To this mixture, 2000 parts by weight of zirconia beads of 0.1 mm diameter were added, and the fine particles were dispersed for 6 hours by the use of a paint shaker to obtain a metal oxide fine particle-containing polysiloxane composition (C3) having a solids concentration of 20% by weight. The results of evaluation of properties of this composition are set forth in Table 2.

### Comparative Example 4

A metal oxide fine particle-containing polysiloxane composition (C4) having a solids concentration of 20% by weight was prepared in the same manner as in Example 3, except that triethylamine was not used. The results of evaluation of properties of this composition are set forth in Table 2.

### Comparative Example 5

A metal oxide fine particle-containing polysiloxane composition (C5) having a solids concentration of 20% by weight was prepared in the same manner as in Example 3, except that 160 parts by weight (80 parts by weight in terms of solid matter) of the polysiloxane solution (ii) were used as a polysiloxane component instead of the polysiloxane solution (I). The results of evaluation of properties of this composition are set forth in Table 2.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Metal oxide fine particles | rutile titanium oxide | | | | | | zinc oxide | zirconium |
| | | | | | | | | oxide |
| Polysiloxane solution | (I) | (II) | (III) | (IV) | (V) | (II) | | (I) |
| Additives | triethylamine | | | | | methanesulfonic | triethylamine | |
| | | | | | | acid | | |
| Dispersibility | A | A | A | A | A | A | A | A |
| Thick film-forming properties | A | A | A | A | A | A | A | A |
| Coating film transparency | A | A | A | A | B | A | A | A |
| Yellowness | A | A | A | A | A | A | A | A |
| Ultraviolet light resistance | A | A | A | A | A | A | A | A |
| Heat resistance | A | A | A | B | A | A | A | A |
| Wet heat resistance | A | A | A | B | A | A | A | A |

TABLE 2

| | Comp. Ex. 1 | Comp. Ex. 2 | Comp. Ex. 3 | Comp. Ex. 4 | Comp. Ex. 5 |
|---|---|---|---|---|---|
| Metal oxide fine particles | rutile titanium oxide | | | | |
| Polysiloxane solution | YF-3800 | (i) | (I) | | (ii) |
| Additives | triethylamine | | PLADD ED151 | — | triethylamine |
| | | | acetylacetone | | |
| Dispersibility | D | A | A | D | A |
| Thick film-forming properties | — | B | A | — | A |
| Coating film transparency | — | occurrence of | D | — | A |
| Yellowness | — | crack in | C | — | A |
| Ultraviolet light resistance | — | baking | — | — | C (whitened) |
| Heat resistance | — | at 200° C. | — | — | D |
| Wet heat resistance | — | | — | — | D |

1. A metal oxide fine particle-containing polysiloxane composition obtained by mixing:
(A) metal oxide fine particles with
(B1) polyfunctional polysiloxane which is obtained by allowing alkoxy-terminated polyfunctional polysiloxane (b1) represented by the following average compositional formula (1):
R¹ₐSiO_{b}(OR²)_{c} (1)
wherein R¹ is a hydrogen atom or a monovalent hydrocarbon group having no oxyalkylene group, when plural R¹ are present, they may be the same as or different from one another, R² is an alkyl group, when plural R² are present, they may be the same as or different from one another, a is more than 0 but less than 2, b is more than 0 but less than 2, c is more than 0 but less than 4, and a+b×2+c=4, and
having a weight-average molecular weight, as measured by gel permeation chromatography, of not less than 3,000 but not more than 100,000 in terms of polystyrene, and hydroxy-terminated polydimethylsiloxane (b2) having a weight-average molecular weight, as measured by gel permeation chromatography, of not less than 2,000 but not more than 100,000 in terms of polystyrene to undergo dealcoholization reaction in a weight ratio (b1/b2) of 30/70 to 95/5 based on 100 parts by weight of the total thereof, or
(B2) polyfunctional polysiloxane which is obtained by allowing hydroxy-terminated polyfunctional polysiloxane (b3) represented by the following average compositional formula (1′):
R¹ₐSiO_{b}(OH)_{c} (1′)
wherein R¹ is a hydrogen atom or a monovalent hydrocarbon group having no oxyalkylene group, when plural R¹ are present, they may be the same as or different from one another, a is more than 0 but less than 2, b is more than 0 but less than 2, c is more than 0 but less than 4, and a+b×2+c=4, and
having a weight-average molecular weight, as measured by gel permeation chromatography, of not less than 3,000 but not more than 100,000 in terms of polystyrene, and alkoxy-terminated polydimethylsiloxane (b4) having a weight-average molecular weight, as measured by gel permeation chromatography, of not less than 2,000 but not more than 100,000 in terms of polystyrene to undergo dealcoholization reaction in a weight ratio (b3/b4) of 30/70 to 95/5 based on 100 parts by weight of the total thereof,
in an organic solvent in the presence of a basic compound, an acidic compound or a metal chelate compound and thereby dispersing the metal oxide fine particles (A) in the organic solvent.

2. The metal oxide fine particle-containing polysiloxane composition as claimed in claim 1, wherein the polyfunctional polysiloxane (B1) or (B2) is further subjected to hydrolysis/condensation and then mixed with the metal oxide fine particles (A).

3. The metal oxide fine particle-containing polysiloxane composition as claimed in claim 2, wherein a catalyst in the hydrolysis/condensation is a basic catalyst.

4. The metal oxide fine particle-containing polysiloxane composition as claimed in any one of claims 1 to 3, wherein a catalyst in the dealcoholization reaction is a metal chelate compound.

5. The metal oxide fine particle-containing polysiloxane composition as claimed in any one of claims 1 to 4, wherein the metal oxide fine particles (A) and the polyfunctional polysiloxane (B1) or (B2) are mixed in the presence of the basic compound.

6. The metal oxide fine particle-containing polysiloxane composition as claimed in any one of claims 1 to 5, wherein the metal oxide fine particles (A) and the polyfunctional polysiloxane (B1) or (B2) are mixed by a bead mill.

7. The metal oxide fine particle-containing polysiloxane composition as claimed in any one of claims 1 to 6, wherein the polyfunctional polysiloxane (B1) or (B2) is mixed in an amount of 1 to 1000 parts by weight in terms of a perfect hydrolysis condensate, based on 100 parts by weight of the metal oxide fine particles (A).

8. A cured product obtained from the metal oxide fine particle-containing polysiloxane composition of any one of claims 1 to 7.

9. An LED sealing material obtained by further mixing the metal oxide fine particle-containing polysiloxane composition of any one of claims 1 to 7 with a fluorescent substance.

10. A process for preparing a metal oxide fine particle-containing polysiloxane composition, comprising preparing:
(B1) polyfunctional polysiloxane which is obtained by allowing alkoxy-terminated polyfunctional polysiloxane (b1) represented by the following average compositional formula (1):
R¹ₐSiO_{b}(OR²)_{c} (1)
wherein R¹ is a hydrogen atom or a monovalent hydrocarbon group having no oxyalkylene group, when plural R¹ are present, they may be the same as or different from one another, R² is an alkyl group, when plural R² are present, they may be the same as or different from one another, a is more than 0 but less than 2, b is more than 0 but less than 2, c is more than 0 but less than 4, and a+b×2+c=4, and
having a weight-average molecular weight, as measured by gel permeation chromatography, of not less than 3,000 but not more than 100,000 in terms of polystyrene, and hydroxy-terminated polydimethylsiloxane (b2) having a weight-average molecular weight, as measured by gel permeation chromatography, of not less than 2,000 but not more than 100,000 in terms of polystyrene to undergo dealcoholization reaction in a weight ratio (b1/b2) of 30/70 to 95/5 based on 100 parts by weight of the total thereof, or
(B2) polyfunctional polysiloxane which is obtained by allowing hydroxy-terminated polyfunctional polysiloxane (b3) represented by the following average compositional formula (1′):
R¹ₐSiO_{b}(OH)_{c} (1′)
wherein R¹ is a hydrogen atom or a monovalent hydrocarbon group having no oxyalkylene group, when plural R¹ are present, they may be the same as or different from one another, a is more than 0 but less than 2, b is more than 0 but less than 2, c is more than 0 but less than 4, and a+b×2+c=4, and
having a weight-average molecular weight, as measured by gel permeation chromatography, of not less than 3,000 but not more than 100,000 in terms of polystyrene, and alkoxy-terminated polydimethylsiloxane (b4) having a weight-average molecular weight, as measured by gel permeation chromatography, of not less than 2,000 but not more than 100,000 in terms of polystyrene to undergo dealcoholization reaction in a weight ratio (b3/b4) of 30/70 to 95/5 based on 100 parts by weight of the total thereof,
and then mixing the polyfunctional polysiloxane (B1) or (B2) with metal oxide fine particles (A) in an organic solvent in the presence of a basic compound, an acidic compound or a metal chelate compound.

11. The process for preparing a metal oxide fine particle-containing polysiloxane composition as claimed in claim 10, wherein the polyfunctional polysiloxane (B1) or (B2) is further subjected to hydrolysis/condensation and then mixed with the metal oxide fine particles (A).

12. The process for preparing a metal oxide fine particle-containing polysiloxane composition as claimed in claim 11, wherein a catalyst in the hydrolysis/condensation is a basic catalyst.

13. The process for preparing a metal oxide fine particle-containing polysiloxane composition as claimed in any one of claims 10 to 12, wherein a catalyst in the dealcoholization reaction is a metal chelate compound.

14. The process for preparing a metal oxide fine particle-containing polysiloxane composition as claimed in any one of claims 10 to 13, wherein the metal oxide fine particles (A) and the polyfunctional polysiloxane (B1) or (B2) are mixed in the presence of the basic compound.

15. The process for preparing a metal oxide fine particle-containing polysiloxane composition as claimed in any one of claims 10 to 14, wherein the metal oxide fine particles (A) and the polyfunctional polysiloxane (B1) or (B2) are mixed by a bead mill.
